(19) United States
(12) Patent Application Publication
(10) Pub. No.: US 2014/0184459 A1
(43) Pub. Date: Jul. 3, 2014

(54) DUAL BAND ANTENNA

(71) Applicant: REALTEK SEMICONDUCTOR CORP., Hsinchu (TW)

(72) Inventors: Sy-Been Wang, Zhubei City (TW); Ching-Wei Ling, Zhubei City (TW); Chih-Pao Lin, Zhubei City (TW)

(73) Assignee: REALTEK SEMICONDUCTOR CORP., Hsinchu (TW)

(21) Appl. No.: 14/140,614

(22) Filed: Dec. 26, 2013

(30) Foreign Application Priority Data
Dec. 28, 2012 (TW) 101151112

(51) Int. Cl. H01Q 5/00

(52) U.S. Cl. CPC H01Q 5/0027
USPC 343/767

(57) ABSTRACT

A dual-band antenna, disposed in a substrate, is provided. The dual-band antenna includes: a feeding part and a slot antenna. The feeding part, disposed on a first side of the substrate, is used for feeding electromagnetic signals with a first resonance frequency and a second resonance frequency, wherein the second resonance frequency is substantially equal to twice the first resonance frequency. The slot antenna includes: a rectangular part with two long edges and two short edges, and a funnel part with a bottom edge, a top edge, and two side edges, wherein the bottom edge is shorter than the top edge, and the two side edges are equal in length substantially, the bottom edge of the funnel part is next to a short edge of the rectangular part, and a center line of the slot antenna corresponds to wavelength of the first frequency.

This application claims the benefit of Taiwan application Serial No. 101151112, filed Dec. 28, 2012, the subject matter of which is incorporated herein by reference.

### BACKGROUND

1. Technical Field

The invention relates in general to an antenna, and more particularly to a dual-band antenna with two operating frequencies.

2. Description of the Related Art

The antenna is one of the essential components of wireless communication equipment, and the quality of the characteristics of the antenna determines the communication quality. Since the wireless communication related products nowadays are intended to provide usefulness with emphasized technology, multiple frequency bands and bandwidths are required.

For example, wireless network standards such as 802.11a/b/g/n utilize the frequency bands of 2400 to 2500 MHz and 5150 to 5850 MHz. In a direct approach, a network product can employ two antennas to receive the two frequency bands respectively. However, such approach employing two antennas is disadvantageous to the manufacturing cost of the product.

Hence, it is desirable, in the related technical fields, to find an approach for providing an antenna which can receive different frequency bands simultaneously, in a simpler way.

### SUMMARY

According to an aspect of the disclosure, a dual-band antenna, disposed in a substrate, is provided. The dual-band antenna includes: a feeding part and a slot antenna. The feeding part, disposed on a first side of the substrate, is used for feeding electromagnetic signals with a first resonance frequency and a second resonance frequency, wherein the second resonance frequency is substantially equal to twice the first resonance frequency. The slot antenna includes: a rectangular part with two long edges and two short edges, and a funnel part with a bottom edge, a top edge, and two side edges, wherein the bottom edge is shorter than the top edge, and the two side edges are equal in length substantially, the bottom edge of the funnel part is next to a short edge of the rectangular part, and a center line of the slot antenna corresponds to wavelength of the first frequency.

According to an embodiment, the dual-band antenna further includes a feeding part, disposed on the substrate, is used for feeding electromagnetic signals, and the location of the feeding part can be changed along the long edge of the rectangular part. When the feeding part is located nearer the funnel part, the second resonant frequency becomes higher.

According to an embodiment of the dual-band antenna, the two side edges of the funnel part makes an included angle with respect to the bottom edge; when the included angle becomes larger, the operating bandwidth of the second resonant frequency becomes wider.

According to an embodiment of the dual-band antenna, the substrate is a printed circuit board or a metal glass fiber board.

According to an embodiment of the dual-band antenna, the first resonant frequency is between 2400 to 2500 MHz, and the second resonant frequency is between 5150 to 5850 Mhz.

According to an embodiment of the dual-band antenna, length of the center line of the slot antenna is equal to a sum of lengths of the long edge of the rectangular part and a center line of the funnel part.

According to an embodiment of the dual-band antenna, a center line of the funnel part is parallel to the long edge of the rectangular part, and the funnel part includes a first sub-funnel part and a second sub-funnel part, which are symmetry with respect to the center line of the funnel part.

According to an embodiment of the dual-band antenna, the first sub-funnel part and the second sub-funnel part have a shape of an acute triangle, a right triangle, or a sector.

According to an embodiment of the dual-band antenna, the sot antenna is located on a second side of the substrate, or on the same side of the substrate and the feeding part.

According to an embodiment of the dual-band antenna, the feeding part is located on a first metal layer, the slot antenna is located on a second metal layer, and the substrate and the first and second metal layers are included in a multi-layered circuit board.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A is a schematic diagram illustrating a dual-band antenna disposed on a substrate according to an embodiment.

FIG. 1B is a schematic diagram illustrating the slot antenna.

FIG. 2 shows the return loss of the slot antenna.

FIGS. 3A, 3B, and 3C are schematic diagrams illustrating the slot antennas according to different embodiments.

FIG. 4A illustrates preferred embodiments with different feeding points at the slot antenna, obtained by changing the location of the feeding part at the slot antenna.

FIG. 4B shows how the return loss is related to the feeding point at the slot antenna.

FIG. 5A illustrates preferred embodiments with different included angles for the funnel part.

FIG. 5B shows the return loss of the slot antenna with respect to the included angle for the funnel part.

FIG. 6 illustrates a preferred embodiment of the dual-band antenna applied in a four-layered printed circuit board.

FIG. 7A is a preferred embodiment with a feeding part disposed on a side of the substrate.

FIG. 7B is a preferred embodiment with a slot antenna disposed on another side of the substrate.

FIG. 7C illustrates a combination of the feeding part in FIG. 7A and the slot antenna in FIG. 7B on two sides of the substrate.

### DETAILED DESCRIPTION

The dual-band antenna according to the disclosure is applicable in wireless transmission products, and can be designed with readily modifications and amendments to achieve required operating frequency bands of the systems, for example, a frequency band requirement for a system utilizing 802.11a/b/g/n (i.e., 2400 to 2500 MHz and 5150 to 5850 MHz). The dual-band antenna according to the disclosure is also applicable in various wireless communication devices, such as: notebook (tablet) computers, wireless network cards, access points, appliances with Wi-Fi (e.g., TV or DVD players) and so on.

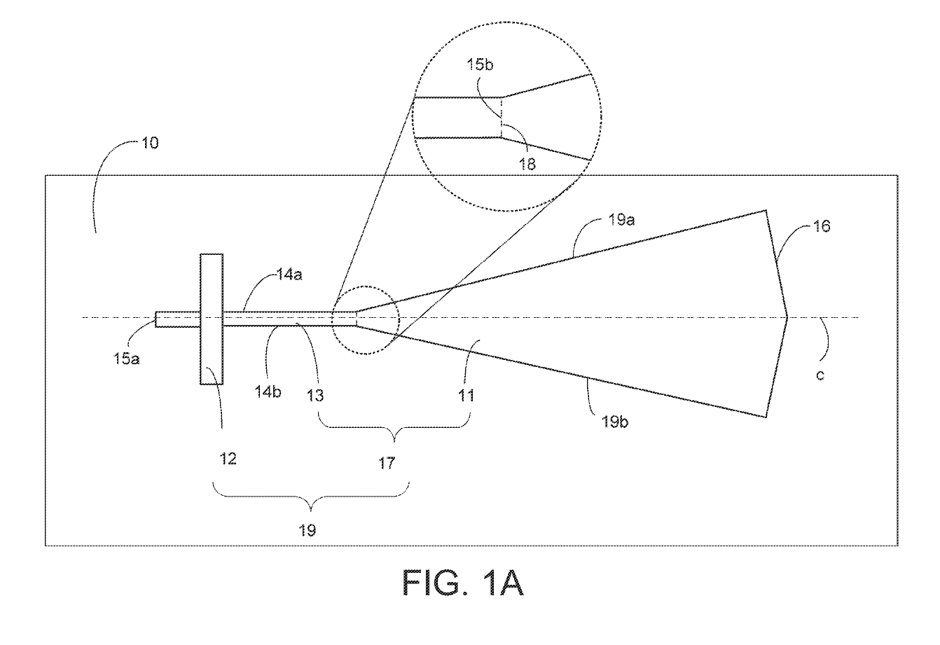

Referring to FIG. 1A, a schematic diagram illustrates a dual-band antenna 19 disposed on a substrate according to an embodiment. In the embodiment, the dual-band antenna 19 is disposed on a substrate 10, such as a printed circuit board, a metal glass fiber board, and so on. While the substrate 10 with both width and length equal to 6 cm is taken as an example for explanation, it is understood that the practical application is not limited thereto.

The dual-band antenna 19 includes a feeding part 12 and a slot antenna 17. The impedance of the feeding part 12 and the communication system are matched with each other so that the feeding part 12 can be utilized in feeding electromagnetic signals with a first resonance frequency and a second resonance frequency. That is, the electromagnetic signals with a first resonance frequency and a second resonance frequency are transmitted to the slot antenna 17 through the feeding part 12, or received by the slot antenna 17 and the feeding part 12.

In the embodiment of FIG. 1A, the slot antenna 17 includes a rectangular part 13 and a funnel part 11. The rectangular part 13 has long edges 14A and 14B and short edges 15a and 15b, where the long edges 14a and 14b are perpendicular to the short edges 15a and 15b.

The funnel part 11 of the slot antenna 17 has a bottom edge 18, a top edge 16, and two side edges 19a and 19b, where the bottom edge 18 is shorter than the top edge 16, and the two side edges 19a and 19b of the funnel part 11 are substantially equal to each other.

From an enlarged view in FIG. 1A, one short edge 15b of the rectangular part 13 is next to the bottom edge 18 of the funnel part 11.

In the design of the slot antenna 17, the shape of the slot antenna 17 is required to satisfy the condition for resonance in order for the slot antenna 17 to transmit or receive signals.

Referring to FIG. 1B, a schematic diagram illustrates the slot antenna according to the embodiment. In the embodiment, the long edges 14a and 14b of the rectangular part 13 are parallel to each other; the short edges 15a and 15b of the rectangular part 13 are also parallel to each other; and the two side edges 19a and 19b of the funnel part 11 respectively extend from the two ends of the bottom edge 18 to the two ends of the top edge 16.

In addition, with respect to a center line c, the top edge 16 of the funnel part 11 can be further divided into top segments 16a and 16b. According to various applications, the top segments 16a and 16b can be designed together as a straight line, a curve, or the segments, as shown in FIG. 1B, making an included angle.

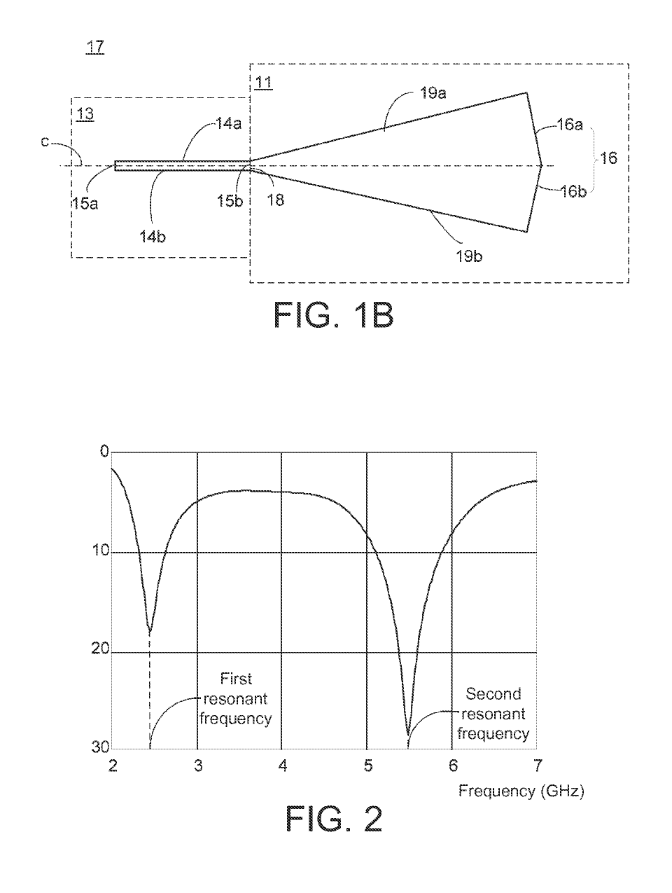

Referring to FIG. 2, the frequency response for return loss of the slot antenna of the embodiment is shown. The frequency response for return loss indicates: how much energy of the electromagnetic signal transmitted by the feeding part 12 and the slot antenna 11 is not transmitted and reflected. It is supposed that the portion of energy not reflected is radiated through the antenna successfully.

Accordingly, when the return loss becomes greater, it indicates that the reflected energy is lesser; i.e., much more energy is radiated successfully. It is taken 10 dB in general as a reference base, and when the return loss is more than 10 dB, it indicates that the energy fed by the feeding part has been effectively transmitted through the antenna.

As illustrated in FIG. 2, the antenna according to the embodiment has two frequency bands satisfying the resonant condition: a first resonant frequency between 2400 to 2500 MHz, and a second resonant frequency between 5150 to 5850 MHz. In other words, the electromagnetic signals with 2400 to 2500 MHz and 5150 to 5850 MHz can be transmitted or received by using the slot antenna and the feeding part.

As discussed above, the dual-band antenna according to the embodiment can radiate the energy of the electromagnetic signal fed by the feeding part with respect to frequencies near the first and second resonant frequencies, to the aft, wherein the second resonant frequency is substantially twice the first resonant frequency.

For the sake of explanation, it is supposed that the first resonant frequency is 2400 MHz, the first wavelength of the first resonant frequency of the dual-band antenna can be determined according to the formula C=f*λ.

It is given the speed of light C=3×10⁸ m/s and then the first wavelength is:

λ=C/f=C=3×10⁸ m/s/2400 MHz=12.5 cm.

The resonant condition can be fulfilled when the length of the antenna is substantially a multiple of the half wavelength, and the resonance makes the slot antenna match with the feeding part. Accordingly, in an embodiment, for the slot antenna, the sum of length of one long edge of the rectangular part and the center line of the funnel part can be designed to be one half of the wavelength; for instance, by considering the effective wavelength λₑ=λ/\sqrt{εᵣ} where εᵣ is an effective dielectric constant for the dielectric, and the required length is λₑ<12.5/2=6.25 cm.

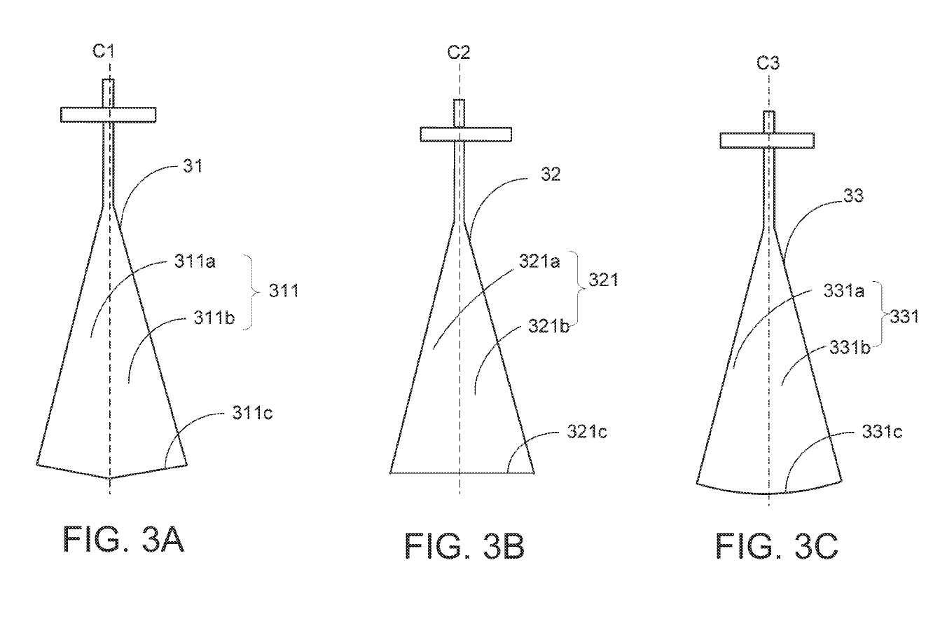

Referring to FIGS. 3A, 3B, and 3C, the shapes of slot antennas according to different embodiments are illustrated. These figures depict that the funnel parts 311, 321, 331 of the slot antennas 31, 32, 33, respectively, can be designed in different shapes.

In the embodiments, with respect to a center line C1 (or C2, C3), the funnel part 311 (or 321, 331) can be divided into two symmetrical sub-funnel parts in the same size: a first sub-funnel part 311a (or 321a, 331a) and a second sub-funnel part 311b (or 321b, 331b).

In the embodiment of FIG. 3A, the top edge 311c of the funnel part 311 is a broken line so that the funnel part 311 is substantially in the shape of a kite. In this case, both the first and the second sub-funnel parts 311a and 311b are acute triangles.

In the embodiment of FIG. 3B, the top edge 321c of the funnel part 321 is a straight line so that the funnel part 311 is substantially in the shape of an isosceles triangle. In this case, both the first and the second sub-funnel parts 321a and 321b are right triangles.

In the embodiment of FIG. 3C, the top edge 331c of the funnel part 331 is a curved line so that the funnel part 311 is substantially in the shape of a sector. In this case, both the first and the second sub-funnel parts 331a and 331b are sectors.

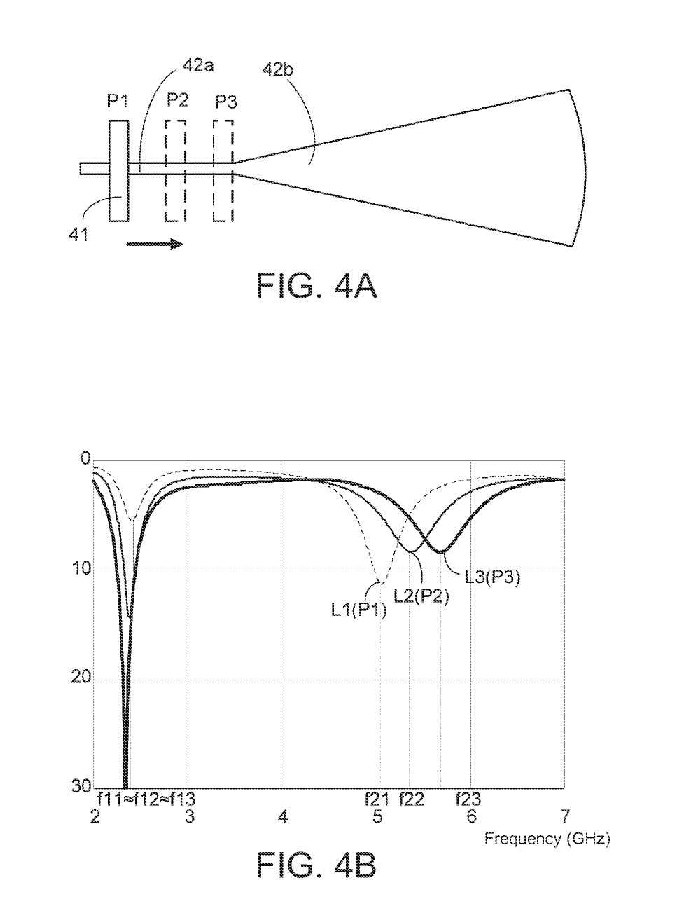

Referring to FIG. 4A, preferred embodiments with different feeding points at the slot antenna are illustrated by changing the location of the feeding part at the slot antenna. As shown in FIG. 4A, a feeding part 41, disposed on the substrate, is used for feeding electromagnetic signals, and the location of the feeding part 41 can be varied by moving the feeding part 41 along the long edge of a rectangular part 42a.

For example, the feeding part 41 is moved along the long edge of the rectangular part 42a towards the funnel part 42b, beginning from a first location P1 to a third location P3 through a second location P2. In addition, the dual-band antenna according to the embodiment may have its second resonant frequency changed by changing the location of the feeding part 41.

Referring to FIG. 4B, the relationship between the changed location of the feeding part and the return loss is illustrated. FIG. 4B corresponds to FIG. 4A, showing that the results of return loss for the dual-band antenna vary according to the location of the feeding part 41.

When the feeding part 41 is at the first location P1, the dual-band antenna has a first resonant frequency f11 and a second resonant frequency f21; likewise, f12 and f22 denote a first resonant frequency and a second resonant frequency when the feeding part 41 is at the second location P2; and f13 and f23 denote a first resonant frequency and a second resonant frequency when the feeding part 41 is at the second location P3.

As shown in FIG. 4B, when the feeding part 41 is at different locations, the first resonant frequencies are substantially the same (f11≈f12≈f13) but the second resonant frequencies vary significantly (f21<f22>f23).

The second resonant frequency f21 for the feeding part 41 at the first location P1 is less than the second resonant frequency f22 for the feeding part 41 at the second location P2. The second resonant frequency f22 for the feeding part 41 at the second location P2 is less than the second resonant frequency f23 for the feeding part 41 at the third location P3.

In other words, when the location of the feeding part 41 is changed towards the funnel part 42B, the second resonant frequency becomes higher. Thus, the dual-band antenna may have its second resonant frequency changed correspondingly by changing the location of the feeding point.

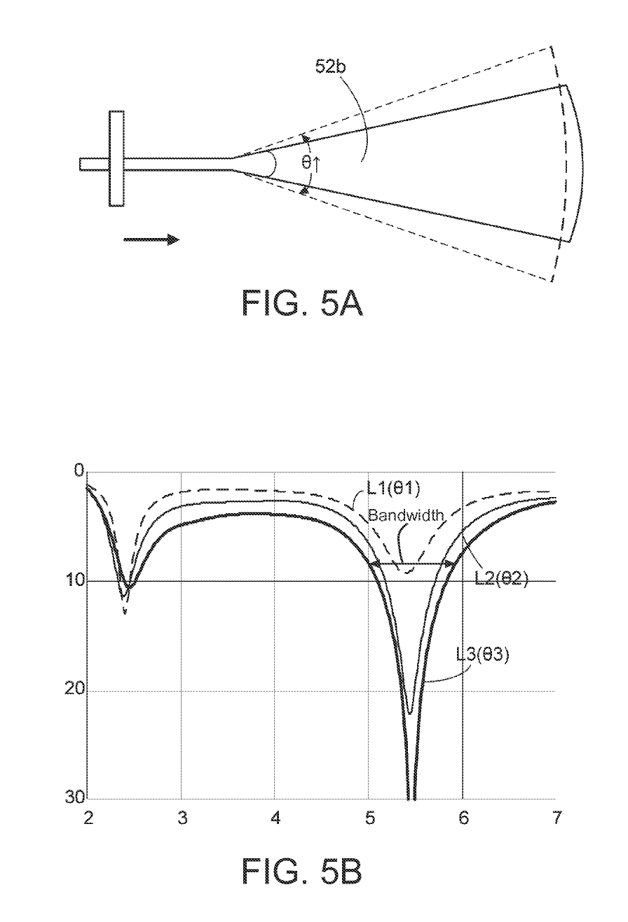

Referring to FIG. 5A, preferred embodiments with different included angles of the funnel part are illustrated by changing the included angle of the funnel part. In the embodiments, the side edges of the funnel part 52b towards the bottom edge of the funnel part 52b make an included angle θ, and the included angle θ can be changed according to the requirement of the bandwidth for the second resonant frequency.

Referring to FIG. 5B, the relationship between the included angle θ for the funnel part and the return loss of signal is shown. FIG. 5B indicates the curves of the frequency response for the included angle θ equal to a first angle θ1=1°, a second angle θ2=11°, and a third angle θ3=21°, respectively.

A first curve L1, a second curve L2, and a third curve L3 represent the frequency response for the included angle θ equal to the first angle θ1, the second angle θ2, and the third angle θ3 respectively.

As shown in FIG. 5B, with respect to the second resonant frequency, the bandwidth for the first curve L1 is less than that for the second curve L2, and the bandwidth for the second curve L2 is less than that for the third curve L3. In other words, the impedance of the slot antenna changes as the included angle θ varies. When the included angle θ becomes larger, the matching of double frequencies becomes better, wherein the bandwidth for the second resonant frequency becomes wider.

Nowadays, multi-layered printed circuit boards (PCB) are commonly employed in wireless communication devices, wherein four-layered PCB is a common type of PCB. The following will explain how to apply the embodiment according to the disclosure to a four-layered board. It is certainly that such application according to the embodiment can be also utilized in other type of multi-layered PCB.

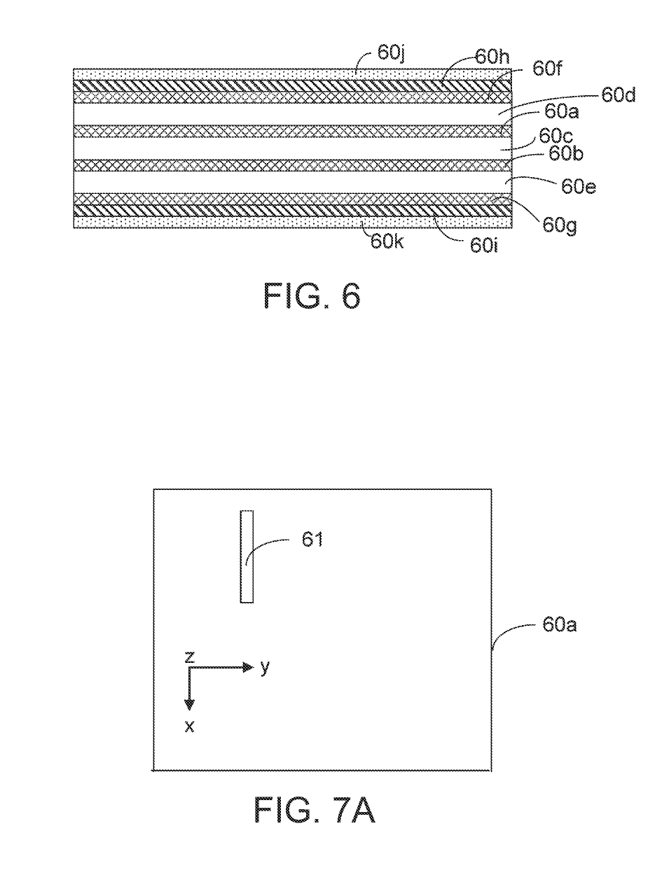

Referring to FIG. 6, the dual-band antenna applied in a four-layered printed circuit board is illustrated according to a preferred embodiment.

According to this sectional view, the four-layered PCB includes a plurality of metal layers and substrates among them, for example, substrates 60c, 60d, and 60e. A portion of the four-layered PCB can be utilized to realize a dual-band antenna according to any embodiment of the disclosure.

It is supposed that the feeding part is located on a first metal layer 60a and the slot antenna is located on a second metal layer 60b, wherein a substrate 60c is sandwiched between the first second metal layer 60a and the second metal layer 60b. In this way, the feeding part can be regarded as a top edge of the substrate 60c, and the slot antenna can be regarded as a bottom edge of the substrate 60c.

In addition, the layers above the first metal layer 60a are copper foil 60f, copper plate 60h, and solder resist (or solder mask) 60j respectively. The layers under the second metal layer 60b are copper foil 60g, copper plate 60i, and solder resist (or solder mask) 60k respectively.

Following that, it is supposed that the PCB employed in the wireless communication device is in the shape of a rectangle, and relative positions among the feeding part, the slot antenna, and the substrate maintain as shown in FIG. 6.

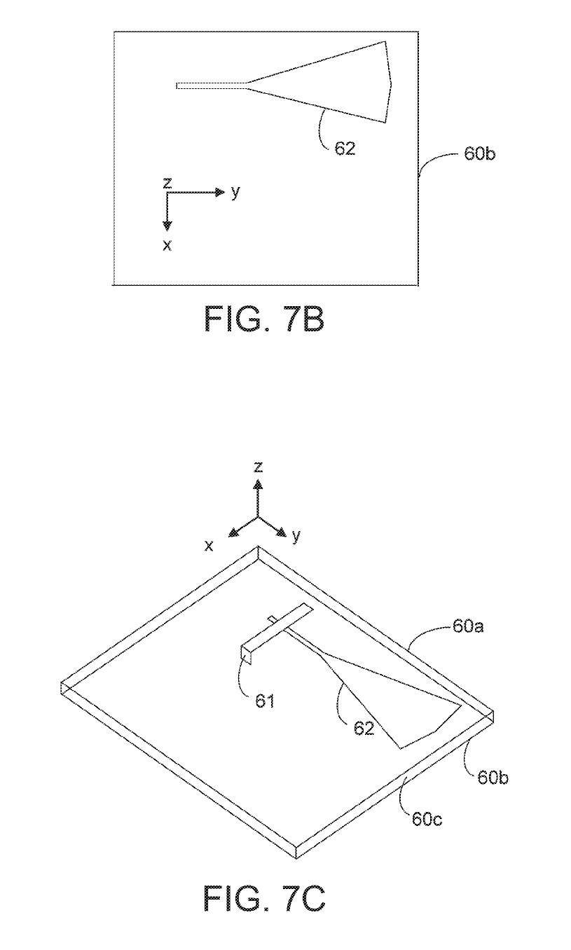

Referring to FIG. 7A, a feeding part disposed on a side of the substrate is illustrated according to a preferred embodiment. This figure is a top view, and the first metal layer 60a is disposed on the top surface of the substrate 60c. It is supposed that a feeding part 61 disposed on the first metal layer 60a is in the shape of a rectangle, the direction of the long edge of the feeding part 61 is parallel to the direction of the short edge of the PCB (e.g., x direction), and the direction of the short edge of the feeding part 61 is parallel to the direction of the long edge of the PCB (e.g., y direction).

Referring to FIG. 7B, a slot antenna disposed on another side of the substrate is illustrated according to a preferred embodiment. This figure is a top view, and the second metal layer 60b is disposed on the bottom surface of the substrate 60c, and a slot antenna 62 can be obtained by hollowing out the second metal layer 60b. It is supposed that the center line of the slot antenna 62 is parallel to the direction of a long edge of the PCB (e.g., y direction). In addition, the rectangular part of the slot antenna 62 is relatively near the left side of the PCB, and the funnel part of the slot antenna 62 is relatively near the right side of the PCB.

Referring to FIG. 7C, a combination of the feeding part in FIG. 7A and the slot antenna in FIG. 7B disposed on two sides of the substrate is illustrated. This figure is equivalent to the result of rotating a combination of FIGS. 7A and 7B with an angle. Since the substrate 60c is relatively thicker, the thickness (e.g., 1.6 mm) of the substrate 60c is presented along the z direction.

As shown in FIG. 7C, if the location of the feeding part 61 is projected onto the second metal layer 60b, the direction of the long edge of the feeding part 61 is perpendicular to the direction of the long edge of the rectangular part of the slot antenna 62. In addition, the feeding part 61 has a portion on one side extends downwards.

While the above embodiment is taken with the slot antenna and the feeding part located on the two sides of the substrate, the metal layers where the slot antenna 62 and the feeding part 61 are located may be on the same side of the substrate. In addition, the feeding part and funnel part can be implemented by any one or two layers of a multi-layered circuit board, without limited to the above embodiments.

As described above, the dual-band antenna according to the embodiment provides the functionality of receiving or transmitting for two different frequency bands simultaneously, and greatly simplifies the manufacturing process of antennas. In addition, the first resonant frequency can be changed by changing the length of the slot antenna, the second resonant frequency can be changed according to the location of the feeding part being moved, and the bandwidth for the second resonant frequency can be changed by changing the angle for the funnel part, thus making the slot antenna suitable for a wider range of applications.

It is noted that while the above embodiments are taken with the frequency bands of 2400 to 2500 MHz and 5150 to 5850 MHz, it is understood that the application of the dual-band antenna according to the disclosure is not limited thereto. Likewise, the embodiment according to the disclosure can be applied to any applications with other requirements for receiving or transmitting for two different frequency bands.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A dual-band antenna, disposed in a substrate, the dual-band antenna comprising:
a feeding part, disposed on a first side of the substrate, for feeding electromagnetic signals with a first resonance frequency and a second resonance frequency, wherein the second resonance frequency is substantially equal to twice the first resonance frequency; and
a slot antenna, comprising:
a rectangular part with two long edges and two short edges, and
a funnel part with a bottom edge, a top edge, and two side edges, wherein the bottom edge is shorter than the top edge, and the two side edges are equal in length substantially, the bottom edge of the funnel part is next to a short edge of the rectangular part, and a center line of the slot antenna corresponds to wavelength of the first frequency.

2. The dual-band antenna according to claim 1, wherein the feeding part is located within the long side of the rectangular part; when the feeding part is located nearer the funnel part, the second resonant frequency becomes higher.

3. The dual-band antenna according to claim 1, wherein the two side edges of the funnel part makes an included angle with respect to the bottom edge; when the included angle becomes larger, the operating bandwidth of second resonant frequency becomes wider.

4. The dual-band antenna according to claim 1, wherein the substrate is a printed circuit board or a metal glass fiber board.

5. The dual-band antenna according to claim 1, wherein the first resonant frequency is between 2400 to 2500 MHz, and the second resonant frequency is between 5150 to 5850 Mhz.

6. The dual-band antenna according to claim 1, wherein length of the center line of the slot antenna is equal to a sum of lengths of the long edge of the rectangular part and a center line of the funnel part.

7. The dual-band antenna according to claim 1, wherein a center line of the funnel part is parallel to the long edge of the rectangular part, and the funnel part includes a first sub-funnel part and a second sub-funnel part, which are symmetry with respect to the center line of the funnel part.

8. The dual-band antenna according to claim 7, wherein the first sub-funnel part and the second sub-funnel part have a shape of an acute triangle, a right triangle, or a sector.

9. The dual-band antenna according to claim 1, wherein the slot antenna is located on a second side of the substrate, or on the same side of the substrate and the feeding part.

10. The dual-band antenna according to claim 1, wherein the feeding part is located on a first metal layer, the slot antenna is located on a second metal layer, and the substrate and the first and second metal layers are included in a multi-layered circuit board.
